(19) United States
(12) Patent Application Publication
(10) Pub. No.: US 2010/0194564 A1
(43) Pub. Date: Aug. 5, 2010

(54) SECURITY SYSTEM INCLUDING PHOTOBEAM CARRYING STATUS INFORMATION

(75) Inventor: William DiPoala, Fairport, NY (US)

Correspondence Address: TAFT STETTINIUS & HOLLISTER LLP, ONE INDIANA SQUARE, SUITE 3500, INDIANAPOLIS, IN, 46204-2023, US

(73) Assignees: Bosch Security Systems, Inc., Fairport, NY (US); Robert Bosch GmbH, Stuttgart (DE)

(21) Appl. No.: 12/362,717

(22) Filed: Jan. 30, 2009

(51) Int. Cl. G08B 13/18

(52) U.S. Cl. 340/556

(57) ABSTRACT

A security method includes transmitting an optical beam from a battery-powered transmitter. The beam carries a tamper signal and/or a battery status signal. The beam is received at a receiver. A radio frequency signal is transmitted from the receiver to a controller. The radio frequency signal includes an alarm signal if there is an interruption of reception of the beam at the receiver. The radio frequency signal is dependent upon the tamper signal and/or battery status signal.

### BACKGROUND OF THE INVENTION

1. Field of the Invention

The present invention relates to a photoelectric beam system, and, more particularly, to a photoelectric beam security system including a battery-powered optical transmitter.

2. Description of the Related Art

Photoelectric beam emitters and their sensors are used for measurement, control and security operations in which the photoelectric beams are broken or restored between the emitters and the sensors. The photoelectric beam arrangement may be used for counting items along a conveyor belt, measuring the size of objects, detecting the position of a machine part, detecting the presence of a human intruder within a secured space, and many other applications.

One type of photoelectric beam arrangement includes an emitter and a receiver in the same housing. Two separate housings, each including an emitter and a receiver, are positioned on opposite sides of an object's path. The photoelectric beam is transmitted from the emitter to the detector across the path.

In these photoelectric systems, the photoelectric beam transmitter unit and the photoelectric beam receiver unit are hard-wired to the alarm system's control panel. Photobeams are often used in an outdoor application to provide perimeter protection around a property. This type of application currently requires long wire runs that need to be buried in the ground. The process of burying the wires is both time-consuming and expensive.

What is neither disclosed nor suggested in the prior art is a method of providing sensed photobeams in an outdoor application that does not require burying of wires between the transmitter and a central controller and between a receiver and a central controller.

### SUMMARY OF THE INVENTION

The present invention is directed to a wireless photoelectric beam incorporating an infrared (IR) communication scheme. An IR light beam is used for both alarm detection and to indicate operational status of an IR transmitter. Alarm and tamper information is sent via a radio frequency (RF) transmitter in a battery-powered IR receiver to an RF receiver at the control panel. An RF signal is sent to the control panel when the battery gets low. IR pulses from the IR transmitter are used to communicate the status of the transmitter's battery and tamper switch to the IR receiver. The IR receiver then forwards this information to the control panel via the RF signal. Thus, there is no need to have an RF transmitter in the IR transmitter's housing. This saves significant cost due to the IR transmitter not requiring RF transmitter circuitry, and reduces the electrical current demands on the battery of the IR transmitter.

The invention comprises, in one form thereof, a security method including transmitting an optical beam from a battery-powered transmitter. The beam carries a tamper signal and/or a battery status signal. The beam is received at a receiver. A radio frequency signal is transmitted from the receiver to a controller. The radio frequency signal includes an alarm signal if there is an interruption of reception of the beam at the receiver. The radio frequency signal is dependent upon the tamper signal and/or battery status signal.

The invention comprises, in another form thereof, a method of operating a security system, including providing an optical beam-emitting apparatus including a battery, a housing, and an optical beam transmitter disposed in the housing and powered by the battery. The housing has an opening with a cover for covering the opening. It is sensed whether the cover has been removed from the opening. An electrical characteristic of the battery is measured. An optical beam is transmitted from the transmitter. The beam carries a tamper signal if it is sensed that the cover has been removed from the opening. The beam carries a low battery signal if the electrical characteristic is measured to be below a threshold value.

The invention comprises, in yet another form thereof, a security method including placing an optical beam-emitting apparatus and an optical beam-receiving apparatus on opposite sides of a space to be monitored. The optical beam-emitting apparatus includes a battery, a housing, and an optical beam transmitter disposed in the housing and powered by the battery. The housing has an access-enabling arrangement. It is sensed whether the access-enabling arrangement has been tampered with. An electrical characteristic of the battery is measured. An optical beam is transmitted from the transmitter toward the optical beam-receiving apparatus. The beam carries a tamper signal if it is sensed that the access-enabling arrangement has been tampered with. The beam carries a low battery signal if the electrical characteristic is measured to be below a threshold value.

An advantage of the present invention is that it is wireless and thus the photobeam transmitter and the photobeam receiver do not need to be connected to a central controller via wires that may need to be buried.

Another advantage is that the transmitted infrared light beam may be used both for sensing the presence of a body between the transmitter and receiver and for communicating the operational status of the infrared transmitter.

Yet another advantage is that there is no need for a radio frequency transmitter in the housing of the optical transmitter. Because an RF transmitter uses a significant amount of power, the current demands on the optical transmitter's battery are greatly reduced. The cost of the system is also significantly reduced due to no RF transmitter circuitry being needed in the housing of the optical transmitter.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a plan view of one embodiment of a security of the present invention.

FIG. 2a is a side view illustrating the range of photobeams transmitted from one embodiment of a transmitter to one embodiment of a receiver of the system of FIG. 1.

FIG. 2b is a view along line 2b-2b of FIG. 2a illustrating the range of photobeams transmitted from one embodiment of a transmitter to one embodiment of a receiver of the system of FIGS. 1 and 2.

FIG. 3a is a plot of a light pulse stream that may be transmitted from the transmitter to the receiver of the system of FIG. 1.

FIG. 3b is a plot of a tamper signal stream that may be transmitted from the transmitter to the receiver of the system of FIG. 1.

FIG. 3c is a plot of a low battery signal stream that may be transmitted from the transmitter to the receiver of the system of FIG. 1.

FIG. 3d is a plot of a low battery and tamper signal stream that may be transmitted from the transmitter to the receiver of the system of FIG. 1.

FIG. 4 is a flow chart of one embodiment of a method of the present invention for operating a security system.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DESCRIPTION OF THE PRESENT INVENTION

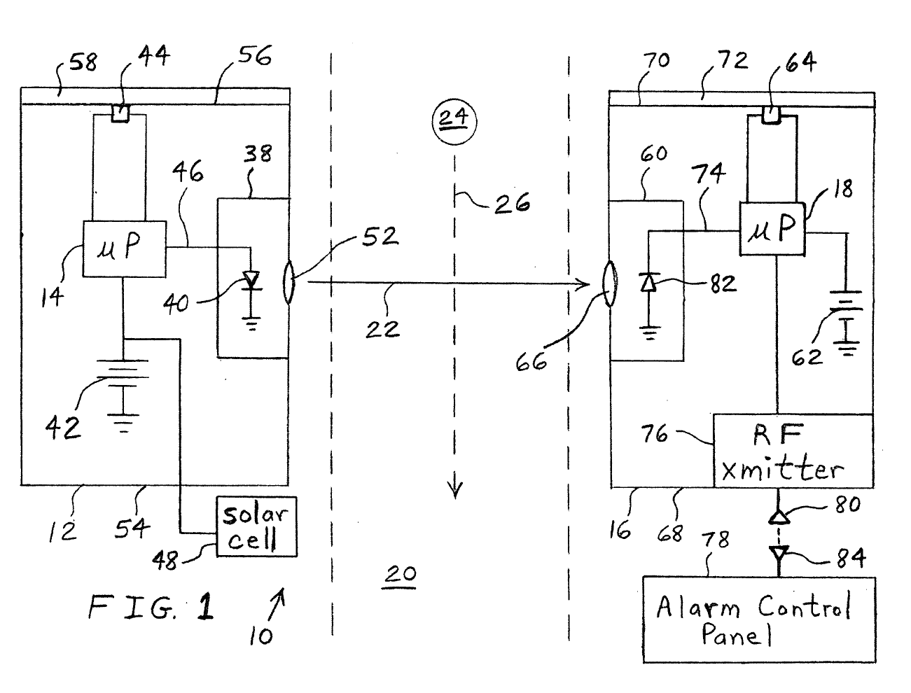

Referring now to the drawings and particularly to FIG. 1, there is shown one embodiment of a security system 10 of the present invention, including an optical beam-emitting apparatus 12 having a microcontroller 14, and an optical beam-receiving apparatus 16 having a microcontroller 18. Optical beam-emitting apparatus 12 and optical beam-receiving apparatus 16 may be disposed on opposite sides of a space to be monitored, such as an outdoor driveway 20. Optical beam-emitting apparatus 12 and optical beam-receiving apparatus 16 may conjointly monitor driveway 20 by respectively transmitting and receiving photobeams, i.e., infrared light energy, indicated by arrow 22. More particularly, optical beam-receiving apparatus 16 may detect when one or more photobeams transmitted by optical beam-emitting apparatus 12 are interrupted, such as by an object 24 moving into the path of the photobeam(s), as indicated by arrow 26. That is, microcontroller 18 may ascertain when a receiver of optical beam-receiving apparatus 16 stops receiving a beam from a transmitter of optical beam-emitting apparatus 12. In one application, system 10 is used to sense the presence of an object 24 in the form of a human intruder, and photobeams 22 are transmitted along the outer boundary or perimeter of a building.

Optical beam-emitting apparatus 12 includes, in addition to microcontroller 14, an opaque optical enclosure 38 containing an LED transmitter 40 of infrared (IR) energy, a battery 42, a switch 44, and a lens 52. Lens 52 may be mounted in a through-hole of a housing 54 that contains all of the above-mentioned components of optical beam-emitting apparatus 12. Housing 54 includes an access-enabling arrangement in the form of an opening 56 that is selectively covered by a lid or cover 58. The operation of transmitter 40 may be controlled by microcontroller 14 via a conductor 46.

Battery 42 may be rechargeable by a solar cell array 48 that is external to housing 54. Solar cells 48 may recharge battery 42 and supplement the power required by transmitter 40 during the day. Battery 42 may provide substantially all power at night and on cloudy days. In one embodiment, solar cell 48 is attached to an outside surface of housing 54. However, it is also possible for the solar cell to be located remotely from housing, perhaps at a location having maximum exposure to sunlight.

Switch 44 may be installed on housing 54 such that switch 44 is tripped by the opening of cover 58, i.e., by the at least partial removal of cover 58 from opening 56. Thus, by monitoring the status of switch 44, microcontroller 14 may prevent someone from gaining access to the inside of optical beam-emitting apparatus 12 and sabotaging system 10 without the human operator of system 10 becoming aware of the sabotage.

Optical beam-receiving apparatus 16 includes, in addition to microcontroller 18, an opaque optical enclosure 60 containing an optical receiver 82 of infrared (IR) energy, a battery 62, a switch 64, and a lens 66. Lens 66 may be mounted in a through-hole of a housing 68 that contains all of the above-mentioned components of optical beam-receiving apparatus 16. Housing 68 includes an access-enabling arrangement in the form of an opening 70 that is selectively covered by a lid or cover 72. Receiver 82 is connected to microcontroller 18 via a conductor 74 such that microcontroller 18 can apply voltage to receiver 82 and sense when receiver 82 is receiving optical energy, as indicated by the changing current draw of receiver 82.

Optical beam-receiving apparatus 16 further includes a radio frequency transmitter 76 for transmitting radio frequency signals to an alarm control panel 78 of system 10, as described below in more detail. Transmitter 76 and panel 78 include respective antennae 80, 84 for this purpose.

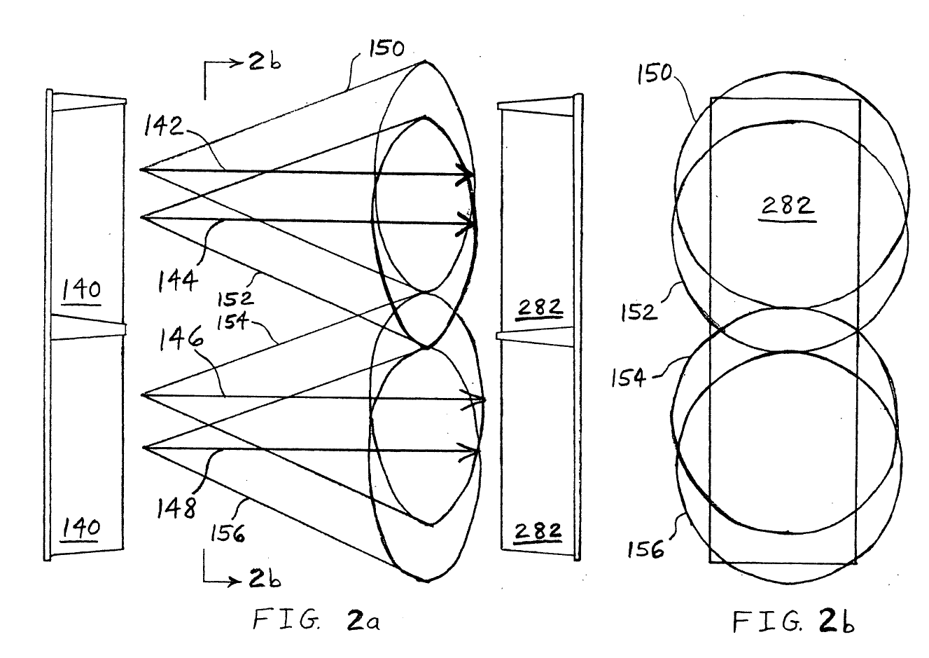

Although transmitter 40 is illustrated schematically as single LED in FIG. 1, it may be in the form of a quad transmitter 140 (FIG. 2a) including a group of four LEDs each emitting a respective one of photobeams 142, 144, 146 and 148. Although photobeams 142, 144, 146, 148 are directed, and may have their peak intensities, along respective linear paths indicated by the arrowheads in FIG. 2a, each of photobeams 142, 144, 146, 148 may be dispersed within a respective one of conical spaces 150, 152, 154, 156. Similarly, although receiver 82 is illustrated schematically as single receiver in FIG. 1, it may be in the form of a quad receiver 282 including a group of four optical energy-sensitive diodes each receiving a respective one of photobeams 142, 144, 146 and 148.

The infrared photobeam 22 (which may be quad beams as shown in FIGS. 2a and 2b) may be in digital form whereby the beam may carry information from transmitting microcontroller 14 to receiving microcontroller 18. This information may include information regarding the status of optical beam-emitting apparatus 12. In the particular embodiment shown in the drawings, the information includes the status of switch 44 and the status of battery 42. The status information may be a warning that switch 44 and/or battery 42 are in a condition such that they need servicing from authorized personnel. In some embodiments, the omission of such a status warning may indicate that the status(es) of switch 44 and/or battery 42 is (are) normal.

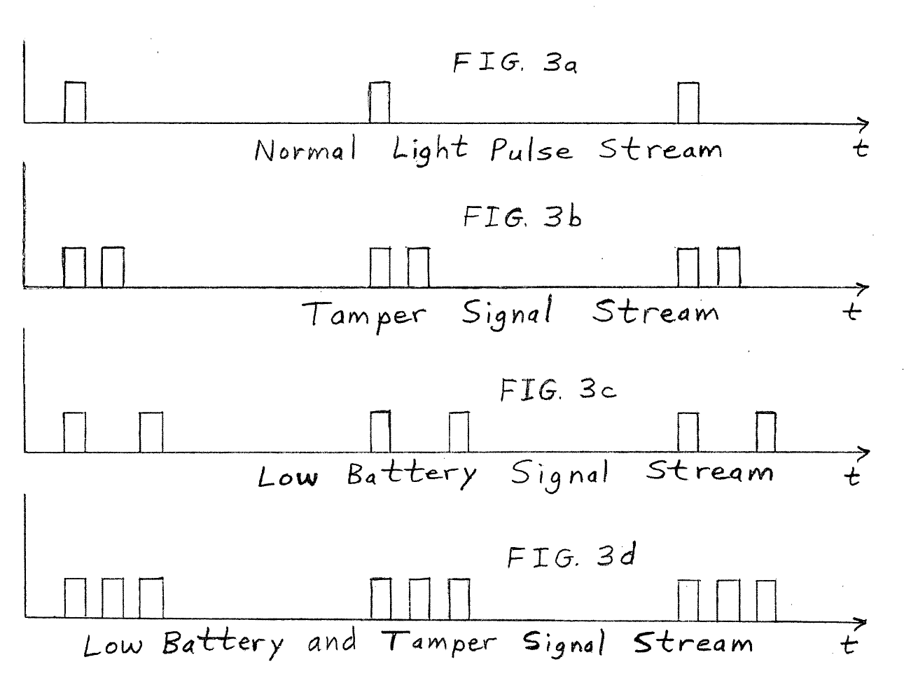

Under default conditions when no warnings about the status of switch 44 and battery 42 are carried, the beam may be a stream of pulses transmitted at regular time intervals, as illustrated in FIG. 3a. The reception of this normal IR pulse stream by the receiver may indicate that there is no object disposed in the optical path between the transmitter and the receiver. This pulsing of the IR photobeam (as opposed to transmitting an IR photobeam of continuous strength) may have the advantage of conserving battery life.

In one embodiment, the photobeams carry eight-bit data packets from optical beam-emitting apparatus 12 to optical beam-receiving apparatus 16. It is also within the scope of the invention for commands and/or data to be carried on the photobeams and transmitted from optical beam-emitting apparatus 12 to optical beam-receiving apparatus 16.

Examples of eight-bit data packets carried by the photobeams are illustrated in FIGS. 3b, 3c and 3d. In the event that microcontroller 14 senses that switch 44 has been tripped, it may be assumed to be the result of cover 58 being removed from opening 56 or otherwise being tampered with. In response to sensing that switch 44 has been tripped, microcontroller 14 may transmit a tamper signal stream illustrated in FIG. 3b and characterized by a pulse being present in the third bit of an eight-bit data packet. Specifically, FIG. 3b illustrates the eight-bit data packet 10100000 being transmitted at regular time intervals. In the illustrated embodiment, this 10100000 represents a Tamper Signal that instructs optical beam-receiving apparatus 16 to transmit a radio frequency signal via RF transmitter 76 to alarm control panel 78. The radio frequency signal includes an indication of tampering. In response to receiving the RF signal with the indication of tampering, alarm control panel 78 may notify human personnel that optical beam-emitting apparatus 12 needs to be inspected and/or serviced. For example, housing 54 may need to be inspected for signs of sabotage, and cover 58 may need to be replaced in opening 56. Alarm control panel 78 may provide the notification to human personnel in the vicinity of panel 78 in the form of a visible light and/or an audible tone. Alarm control panel 78 may provide the notification to remote human personnel, such as local police or personnel at a central monitoring station, via telephone communication.

In the event that microcontroller 14 senses that the voltage, or some other electrical characteristic, of battery 42 has fallen below a threshold value, it may be assumed that battery 42 needs to be replaced. Rechargeable batteries may fail in approximately three to five years. Even before the batteries fail, they may need to be replaced or manually recharged in the event that the solar cells do not receive a sufficient amount of sunlight over a period of days. In response to sensing that the voltage of battery 42 has fallen below the threshold value, microcontroller 14 may transmit a low battery signal stream illustrated in FIG. 3c and characterized by a pulse being present in the fifth bit of an eight-bit data packet. Specifically, FIG. 3c illustrates the eight-bit data packet 10001000 being transmitted at regular time intervals. In the illustrated embodiment, this 10001000 represents a Low Battery Signal that instructs optical beam-receiving apparatus 16 to transmit a radio frequency signal via RF transmitter 76 to alarm control panel 78. The radio frequency signal includes an indication of the low voltage status of battery 42. In response to receiving the RF signal with the indication of low battery voltage, alarm control panel 78 may notify human personnel that the battery of optical beam-emitting apparatus 12 needs to be replaced. Alarm control panel 78 may provide the notification to human personnel in the vicinity of panel 78 in the form of a visible light and/or an audible tone. Alarm control panel 78 may provide the notification to remote human personnel, such as personnel at a central monitoring station, via telephone communication.

In the event that microcontroller 14 senses both that switch 44 has been tripped and that the voltage of battery 42 has fallen below a threshold value, microcontroller 14 may transmit a low battery and tamper signal stream illustrated in FIG. 3d and characterized by pulses being present in the third and fifth bits of an eight-bit data packet. Specifically, FIG. 3d illustrates the eight-bit data packet 10101000 being transmitted at regular time intervals. In the illustrated embodiment, this 10101000 represents a Low Battery and Tamper Signal that instructs optical beam-receiving apparatus 16 to transmit a radio frequency signal via RF transmitter 76 to alarm control panel 78. The radio frequency signal includes both an indication of tampering and an indication of the low voltage status of battery 42. In response to receiving the RF signal with the indication of tampering and low battery voltage, alarm control panel 78 may notify human personnel that optical beam-emitting apparatus 12 needs to be inspected and/or serviced and that battery 42 needs to be replaced. Alarm control panel 78 may provide the notification to human personnel in the vicinity of panel 78 in the form of one or two visible lights and/or one or two audible tones of different frequency. Alarm control panel 78 may provide the notification to remote human personnel, such as local police or personnel at a central monitoring station, via telephone communication.

During operation, IR photobeam 22 may be continuously transmitted across the monitored space. Microcontroller 18 may periodically verify that a photobeam continues to be received by receiver 82. In one embodiment, if for some reason microcontroller 14 plans to stop transmitting, then microcontroller 14 transmits a message to microcontroller 18 so indicating. Thus, microcontroller 18 will no longer expect to receive the photobeam after receiving the message. For example, if the seventh bit of the eight-bit data packet is set, it may indicate that microcontroller 14 plans to stop transmitting.

In the event that an object 24 moves into position between optical beam-emitting apparatus 12 and optical beam-receiving apparatus 16, then photobeam 22 is broken by object 24 so that reception at receiver 82 is interrupted. Microcontroller 18, which is no longer receiving the photobeam, may transmit a radio frequency alarm signal to alarm control panel 78 via RF transmitter 76. In response to receiving the alarm signal, alarm control panel 78 may cause an audible siren to be activated, and/or may send a secondary alarm signal to a central monitoring station via telephone lines so that an appropriate authority, such as local police, may be dispatched to the location of system 10 to investigate whether object 24 is a human intruder.

It is also possible within the scope of the invention for tampering and/or low battery status of optical beam-receiving apparatus 16 to be communicated to alarm control panel 78 via radio signals transmitted by RF transmitter 76. The detection of tampering with optical beam-receiving apparatus 16 via switch 64 and the monitoring of its battery 62 may be substantially similar to that described above for optical beam-emitting apparatus 12, and thus is not described in detail herein in order to avoid needless repetition.

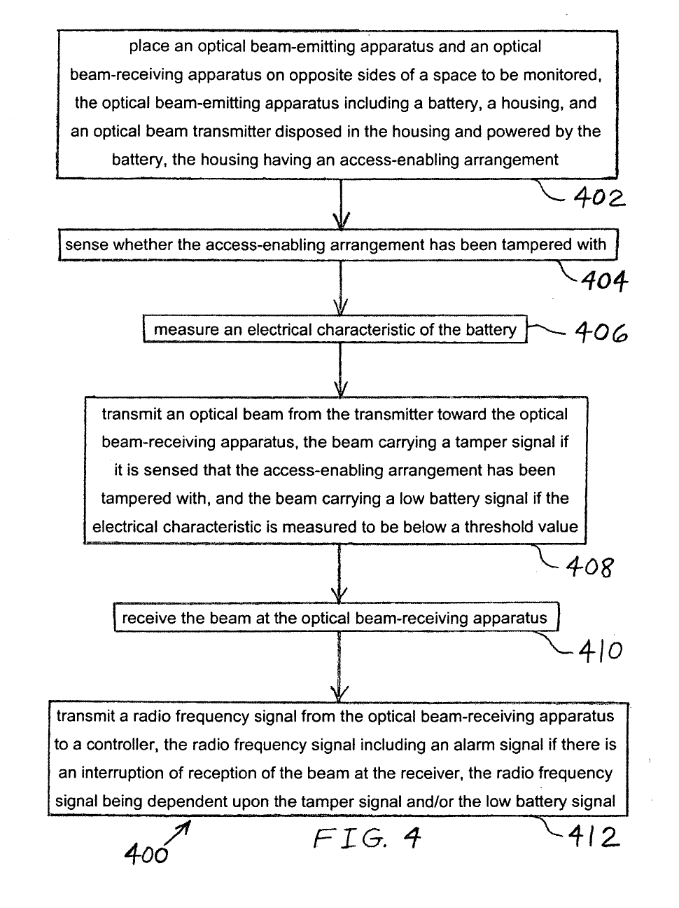

FIG. 4 illustrates one specific embodiment of a method 400 of the present invention for operating a security system. In a first step 402, an optical beam-emitting apparatus and an optical beam-receiving apparatus are placed on opposite sides of a space to be monitored. The optical beam-emitting apparatus includes a battery, a housing, and an optical beam transmitter disposed in the housing and powered by the battery. The housing has an access-enabling arrangement. For example, optical beam-emitting apparatus 12 and optical beam-receiving apparatus 16 may be placed on opposite sides of a driveway 20 to be monitored. Optical beam-emitting apparatus 12 includes a battery 42, a housing 54, and an optical beam transmitter 40 disposed in housing 54 and powered by battery 42. Housing 54 has an access-enabling arrangement in the form of an opening 56 in housing 54 which is covered by a cover 58.

In a next step 404, it is sensed whether the access-enabling arrangement has been tampered with. That is, microcontroller 14 may sense whether switch 44 has been tripped, which is indicative of cover 58 being removed from opening 56.

In step 406, an electrical characteristic of the battery is measured. For example, microcontroller 14 may measure the output voltage of battery 42.

In a next step 408, an optical beam is transmitted from the transmitter toward the optical beam-receiving apparatus. The beam carries a tamper signal if it is sensed that the access-enabling arrangement has been tampered with. The beam carries a low battery signal if the electrical characteristic is measured to be below a threshold value. In one embodiment, optical beam 22 is transmitted from transmitter 40 toward optical beam-receiving apparatus 16. Microcontroller 14 may cause beam 22 to carry a tamper signal, as shown in FIG. 3b, if microcontroller 14 senses that switch 44 has been tripped. Microcontroller 14 may cause beam 22 to carry a low battery signal, as shown in FIG. 3c, if microcontroller 14 senses that the voltage of battery 42 is below a threshold voltage. Microcontroller 14 may cause beam 22 to carry both a tamper signal and a low battery signal, as shown in FIG. 3d, if microcontroller 14 senses both that switch 44 has been tripped and the voltage of battery 42 is below a threshold voltage.

Next, in step 410, the beam is received at the optical beam-receiving apparatus. That is, photobeam 22 may be received at optical beam-receiving apparatus 16.

In a final step 412, a radio frequency signal is transmitted from the optical beam-receiving apparatus to a controller. The radio frequency signal includes an alarm signal if there is an interruption of reception of the beam at the receiver. The radio frequency signal is dependent upon the tamper signal and/or the low battery signal. In a particular example, a radio frequency signal is transmitted from optical beam-receiving apparatus 16 to a controller in the form of alarm control panel 78. The radio frequency signal may include an alarm signal, such as a signal at a certain predetermined radio frequency, in response to receiver 82 suddenly no longer receiving photobeam 22. The radio frequency signal may also include an indication of photobeam 22 carrying a tamper signal string and/or a low battery signal stream.

The present invention has been described herein as detecting tampering through the tripping of switch 44. However, the invention may encompass other forms of tampering detection, such as sensing the breaking of a thin electrical conductor attached to both the housing and its cover when the cover is removed or pulled away from an opening of the housing.

An electrical characteristic in the form of battery voltage is described herein as being monitored by the present invention. It is to be understood that other types of electrical characteristics of the battery may alternatively be monitored, such as the output current of the battery, for example.

The invention has been described with an eight-bit digital packet being carried by photobeam 22. However, it is also within the scope of the invention for information to be carried by photobeam 22 in analog form, or in data packets of different or varying length.

While this invention has been described as having an exemplary design, the present invention may be further modified within the spirit and scope of this disclosure. This application is therefore intended to cover any variations, uses, or adaptations of the invention using its general principles.

What is claimed is:

1. A security method, comprising the steps of:
transmitting an optical beam from a battery-powered transmitter, the beam carrying at least one of a tamper signal and a battery status signal;
receiving the beam at a receiver; and
transmitting a radio frequency signal from the receiver to a controller, the radio frequency signal including an alarm signal if there is an interruption of reception of the beam at the receiver, the radio frequency signal being dependent upon the at least one of a tamper signal and a battery status signal.

2. The method of claim 1 wherein the radio frequency signal is indicative of the optical beam carrying the at least one of a tamper signal and a battery status signal.

3. The method of claim 1 comprising the further step of placing the transmitter and the receiver on opposite sides of a space to be monitored.

4. The method of claim 1 wherein the transmitter is powered by a battery, the battery status signal being indicative of a status of the battery.

5. The method of claim 4 wherein the radio frequency signal includes an indication of the status of the battery.

6. The method of claim 1 wherein the transmitter is disposed in a housing, the tamper signal being indicative of whether the housing has been opened.

7. The method of claim 1 wherein the radio frequency signal includes an indication of tampering if the beam carries a tamper signal.

8. A method of operating a security system, comprising the steps of:
providing an optical beam-emitting apparatus including a battery, a housing, and an optical beam transmitter disposed in the housing and powered by the battery, the housing having an opening with a cover for covering the opening;
sensing whether the cover has been removed from the opening;
measuring an electrical characteristic of the battery; and
transmitting an optical beam from the transmitter, the beam carrying a tamper signal if it is sensed that the cover has been removed from the opening, and the beam carrying a low battery signal if the electrical characteristic is measured to be below a threshold value.

9. The method of claim 8 comprising the further steps of:
receiving the optical beam at a receiver; and
transmitting a radio frequency signal from the receiver to a controller, the radio frequency signal including:
an alarm signal if there is an interruption of reception of the beam at the receiver;
an indication of tampering if the beam carries a tamper signal; and
a low battery indication if the beam carries a low battery signal.

10. The method of claim 9 comprising the further step of placing the optical beam-emitting apparatus and the receiver on opposite sides of a space to be monitored.

11. The method of claim 9 wherein the controller comprises an alarm control panel of the security system.

12. The method of claim 8 wherein the electrical characteristic comprises a voltage.

13. The method of claim 8 wherein the optical beam is transmitted along a boundary of a building.

14. The method of claim 8 comprising the further step of installing a switch on the housing such that the switch is tripped when the cover is removed from the opening.

15. A security method, comprising the steps of:
placing an optical beam-emitting apparatus and an optical beam-receiving apparatus on opposite sides of a space to be monitored, the optical beam-emitting apparatus including a battery, a housing, and an optical beam transmitter disposed in the housing and powered by the battery, the housing having an access-enabling arrangement;
sensing whether the access-enabling arrangement has been tampered with;
measuring an electrical characteristic of the battery; and
transmitting an optical beam from the transmitter toward the optical beam-receiving apparatus, the beam carrying a tamper signal if it is sensed that the access-enabling arrangement has been tampered with, and the beam carrying a low battery signal if the electrical characteristic is measured to be below a threshold value.

16. The method of claim 15 comprising the further steps of:
receiving the optical beam at the optical beam-receiving apparatus; and
transmitting a radio frequency signal from the optical beam receiving apparatus to a controller, the radio frequency signal including:
an alarm signal if there is an interruption of reception of the beam at the optical beam-receiving apparatus;
an indication of tampering if the beam carries a tamper signal; and
a low battery indication if the beam carries a low battery signal.

17. The method of claim 15 wherein the access-enabling arrangement comprises an opening in the housing and a cover for covering the opening.

18. The method of claim 17 wherein the sensing step comprises sensing whether the cover has been at least partially removed from the opening.

19. The method of claim 15 wherein the optical beam comprises a pulse stream including a multiple-bit data packet that is repeatedly transmitted.

20. The method of claim 19 wherein each of the tamper signal and the low battery signal comprises a respective bit or set of bits in the data packet.
